(19) United States
(12) Patent Application Publication
(10) Pub. No.: US 2024/0388211 A1
(43) Pub. Date: Nov. 21, 2024

(54) FLYBACK CONVERTERS WITH IMPROVED PERFORMANCE AND THE CONTROL AND DRIVE CIRCUIT THEREOF

(71) Applicant: Chengdu Monolithic Power Systems Co., Ltd., Chengdu, Sichuan (CN)

(72) Inventors: Xia Zhou, Hangzhou (CN); Xuefeng Chen, Hangzhou (CN); Hui Li, Hangzhou (CN)

(21) Appl. No.: 18/667,878

(22) Filed: May 17, 2024

(30) Foreign Application Priority Data
May 19, 2023 (CN) 202310573420.8

(51) Int. Cl. H02M 3/335; H02M 1/00; H02M 1/36

(52) U.S. Cl. CPC H02M 3/33576; H02M 1/36; H02M 1/0058

(57) ABSTRACT

A flyback converter with improved performance is discussed. The flyback converter has a control and drive circuit, which drives the primary power switch with a weak drive if the time interval between two adjacent turn-ons of the primary power switch is longer than the reference time length; and drives the primary power switch with a strong drive if the time interval between two adjacent turn-ons of the primary power switch is shorter than the reference time length.

### CROSS-REFERENCE TO RELATED APPLICATIONS

This application claims priority to and the benefit of Chinese Patent Application No. 202310573420.8, filed May 19, 2023, which is incorporated herein by reference in its entirety.

### BACKGROUND OF THE INVENTION

Flyback converters are widely used in the applications of converting an alternate current (AC) into a direct current (DC). Typically, the flyback converter comprises: a transformer T having a primary winding TO and a secondary winding T1, a primary switch Q0, a secondary switch Q1, and a voltage type snubber RCD, as shown in FIG. 1.

Zero-voltage switching technology is typically used in the flyback converter to reduce the switching loss of the primary switch. The so-called zero-voltage switching technology means that: the secondary switch Q1 will be turned on for an additional time after the freewheel process is over before the primary switch Q0 is turned on, or an auxiliary switch Q2 series coupled to an auxiliary winding T2 (as shown in FIG. 1 with dashed line) will be turned on for an additional time before the primary switch Q0 is turned on, to ensure the primary switch Q0 to be turned on with a zero drain-source voltage. A negative magnetic current would be generated at the primary side during this additional ON time, causing a large oscillation amplitude of the primary switch Q0 at the discontinuous current mode. Then the primary switch Q0 would have a relative low turn-on voltage.

However, the converter may enter a burst mode as the load of the converter decreases; and may exit the burst mode when the load increases. The voltage across the voltage type snubber RCD would decrease to a very low value during this period. If the secondary switch is turned on for an additional time before the primary switch is turned on, the current flowing through the secondary switch is large, resulting in a high output voltage ripple.

### SUMMARY OF THE INVENTION

In accordance with an embodiment of the present invention, a flyback converter is discussed. The flyback converter comprises: a primary power switch, coupled to a primary winding of a transformer; a secondary power switch, coupled to a secondary winding of the transformer; and a driver, configured to provide a drive signal to drive the primary power switch. If a time interval between two adjacent turn-ons of the primary power switch is longer than a reference time length, the driver is configured to provide a weak drive, so that the primary power switch is controlled to turn to a fully ON state from a fully OFF state with a first speed. If the time interval between two adjacent turn-ons of the primary power switch is shorter than the reference time length, the driver is configured to provide a strong drive, so that the primary power switch is controlled to turn to the fully ON state from the fully OFF state with a second speed.

In addition, in accordance with an embodiment of the present invention, a control and drive circuit is discussed. The control and drive circuit comprises: a primary controller, configured to generate a primary control signal used to control a primary power switch; and a timer, configured to time a time interval between two adjacent turn-ons of the primary power switch. If the time interval between two adjacent turn-ons of the primary power switch is longer than a reference time length, the primary controller is configured to control the primary power switch to turn to a fully ON state from a fully OFF state with a first speed. If the time interval between two adjacent turn-ons of the primary power switch is shorter than the reference time length, the primary controller is configured to control the primary power switch to turn to the fully ON state from the fully OFF state with a second speed.

Furthermore, in accordance with an embodiment of the present invention, a control and drive circuit is discussed. The control and drive circuit comprises: a primary controller, configured to generate a primary control signal used to control a primary power switch; and a driver, configured to provide a drive signal to drive the primary power switch. If a time interval between two adjacent turn-ons of the primary power switch is longer than a reference time length, the driver is configured to provide a weak drive, to have the primary power switch turn to a fully ON state from a fully OFF state with a first speed. If the time interval between two adjacent turn-ons of the primary power switch is shorter than the reference time length, the driver is configured to provide a strong drive, to have the primary power switch turn to the fully ON state from the fully OFF state with a second speed.

### BRIEF DESCRIPTION OF DRAWINGS

FIG. 1 schematically shows a circuit configuration of a typical flyback converter.

FIG. 2 schematically shows a flyback converter 200 in accordance with an embodiment of the present invention.

FIG. 3 schematically shows waveforms of a drive current I_{G} provided by the driver 120 under different conditions in accordance with an embodiment of the present invention.

FIG. 4 schematically shows a waveform of the drive signal DR with a weak drive current in accordance with an embodiment of the present invention.

FIG. 5 schematically shows a waveform of the drive signal DR with a strong drive current in accordance with an embodiment of the present invention.

FIG. 6 schematically shows a circuit configuration of the driver 120 in accordance with an embodiment of the present invention.

FIG. 7 schematically shows a flyback converter 700 with a circuit configuration of the control circuit 110 in accordance with an embodiment of the present invention.

FIG. 8 schematically shows a flyback converter 800 with a circuit configuration of the control circuit 110 in accordance with an embodiment of the present invention.

FIG. 9 schematically shows a flowchart 900 of a method used in a flyback converter in accordance with an embodiment of the present invention.

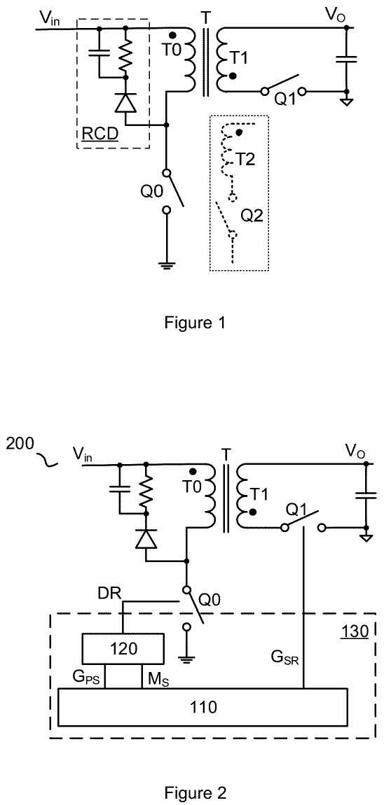

### DETAILED DESCRIPTION OF THE INVENTION

Embodiments of circuits for flyback converter are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

FIG. 2 schematically shows a flyback converter 200 in accordance with an embodiment of the present invention. In the example of FIG. 2, the flyback converter 200 comprises: a primary power switch Q0, coupled to a primary winding TO of a transformer T; and a secondary power switch Q1, coupled to a secondary winding T1 of the transformer T. the flyback converter 200 further comprises: a control and drive circuit 130, having a control circuit 110, configured to provide a primary control signal G_{PS}, a secondary control signal G_{SR}, and a monitor signal M_{S}; and a driver 120, configured to generate a drive signal DR to drive the primary power switch Q0 in response to the primary control signal G_{PS} and the monitor signal M_{S}. The primary power switch Q0 and the secondary power switch Q1 are controlled to be periodically turned on and off under the control of the control circuit 110, to convert an input voltage Vᵢₙ into an output voltage V_{O}. If there is a condition that a time interval between two adjacent turn-ons of the primary power switch Q0 is longer than a reference time length, the monitor signal M_{S} is operable to control the driver 120 to provide a weak drive, so that the primary power switch Q0 is controlled to turn to a fully ON state from a first state (i.e. fully OFF) with a first speed. If the time interval between two adjacent turn-ons of the primary power switch Q0 is shorter than the reference time length, the monitor signal M_{S} is configured to control the driver 120 to provide a strong drive, so that the primary power switch Q0 is controlled to turn to be fully ON from fully OFF with a second speed.

In one embodiment of the present invention, the first speed is lower than the second speed. That is, the primary power switch Q0 needs a longer time to turn to be fully ON from fully OFF under the weak drive.

In one embodiment of the present invention, two adjacent turn-ons of the primary power switch Q0 may refer to the primary power switch Q0 is consecutively turned on twice. The time interval of between two adjacent turn-ons of the primary power switch may also be regarded as a switching cycle, or a switching period in a normal operation mode.

In one embodiment of the present invention, the flyback converter 200 enters a burst mode as a load of the flyback converter decreases; and exists from the burst mode as the load increases. When the flyback converter is under the normal operation mode (e.g., is not under the burst mode or not at a start-up stage), the time interval between two adjacent turn-ons of the primary power switch Q0 is shorter than the reference time length, the monitor signal M_{S} is operable to control the driver 120 to provide the strong drive, so that the primary power switch Q0 is controlled to turn to be fully ON from fully OFF with the second speed. When the flyback converter enters the burst mode and then exits from the burst mode, the time interval between two adjacent turn-ons of the primary power switch Q0 is longer than the reference time length, the monitor signal M_{S} is operable to control the driver 120 to provide the weak drive, so that the primary power switch Q0 is controlled to turn to be fully ON from fully OFF with the first speed.

In one embodiment of the present invention, the driver 120 provides a strong drive means that the driver 120 may provide a relatively high drive current, or a relatively high drive voltage, or a relatively strong drive pulse, so that the drive signal DR increases rapidly, to have the primary power switch Q0 rapidly turn to a fully ON state from a fully OFF state. The driver 120 provides a weak drive means that the driver 120 may provide a relatively low drive current, or a relatively low drive voltage, or a relatively weak drive pulse, so that the drive signal DR increases slowly, to have the primary power switch Q0 slowly turn to the fully ON state from the fully OFF state.

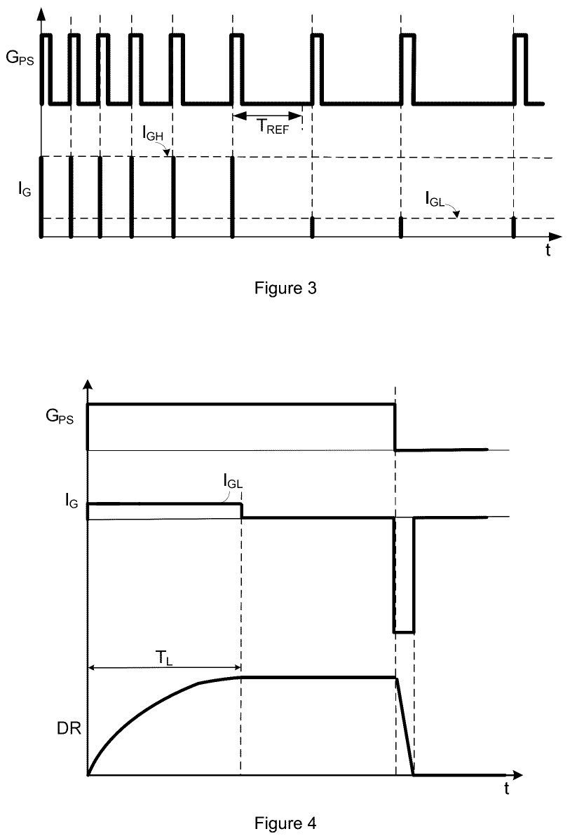

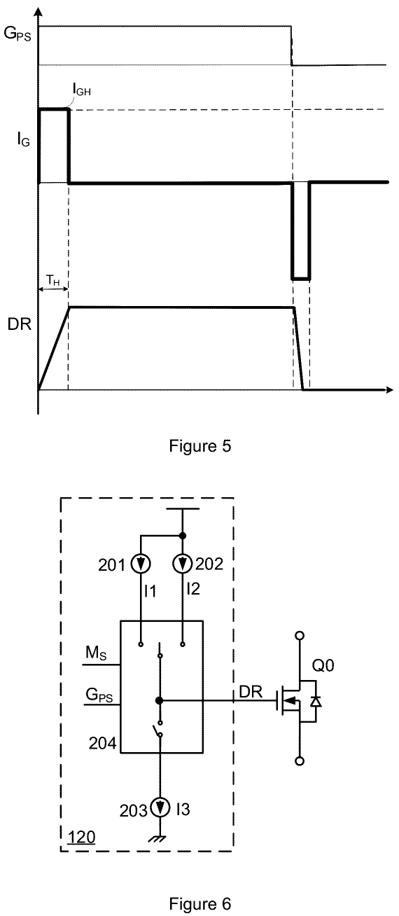

FIG. 3 schematically shows waveforms of a drive current Is provided by the driver 120 under different conditions in accordance with an embodiment of the present invention. FIG. 4 schematically shows a waveform of the drive signal DR with a weak drive current in accordance with an embodiment of the present invention. FIG. 5 schematically shows a waveform of the drive signal DR with a strong drive current in accordance with an embodiment of the present invention. As shown in FIG. 3, when a time interval between two primary control signals (G_{PS}) is longer than the reference time length T_{REF}, the drive current I_{G} provided by the driver 120 is relatively small (shown as a small drive current I_{GL} in FIG. 3). The drive signal DR slowly increases from low to high, and the primary power switch Q0 is slowly turned on, as shown in FIG. 4. When the time interval between two primary control signals (G_{PS}) is shorter than the reference time length T_{REF}, the drive current I_{G} provided by the driver 120 is relatively large (shown as a large drive current I_{GH} in FIG. 3). The drive signal DR fast increases from low to high, and the primary power switch Q0 is fast turned on, as shown in FIG. 5.

In one embodiment of the present invention, the primary power switch Q0 and the secondary power switch Q1 are idle (i.e. the control circuit 110 would not control the primary power switch Q0 and the secondary power switch Q1 to switch between the ON and OFF states) when the flyback converter 200 is under the burst mode.

In one embodiment of the present invention, the control circuit 110 is configured to provide a weak drive during a start-up process of the flyback converter 200, to control the primary power switch Q0 to turn to the fully ON state from the fully OFF state with the first speed.

In one embodiment of the present invention, the primary power switch Q0 and the secondary power switch Q1 may each comprise a mental oxide field effect transistor (MOSFET). However, one skilled in the art should realize that the primary power switch Q0 and the secondary power switch Q1 may comprise other controllable power devices, such as BJT, IGBT, GaN FET, SiC FET and cascode circuit (e.g., a cascade circuit of a JFET with a MOSFET).

When the flyback converter 200 is under the normal operation mode, the secondary power switch Q1 is turned on after the primary power switch Q0 is turned off, until an OFF condition of is met; then the secondary power switch Q1 is turned on again for an additional time before the primary power switch Q0 is turned on at the next switching cycle. When the flyback converter 200 enters the burst mode and then exits from the burst boost, the secondary power switch Q1 will not be turned on again for the additional time before the primary power switch Q0's turn-on at the next switching cycle. Specifically speaking, at the first N switching cycles just after the flyback converter 200 exits from the burst mode, the control circuit 110 does not control the secondary power switch Q1 to be turned on again for the additional time before the primary power switch Q0's turn-on at the next switching cycle. And after the first N switching cycles since the flyback converter exits from the burst mode, the control circuit 110 controls the secondary power switch Q1 to be turned on again for the additional time before the primary power switch Q0's turn-on at the next switching cycle. N is an integer larger than 1.

FIG. 6 schematically shows a circuit configuration of the driver 120 in accordance with an embodiment of the present invention. As shown in FIG. 6, the driver 120 comprises: a first current source 201, configured to provide a first drive current I1; a second current source 202, configured to provide a second drive current 12; and a third current source 203, configured to provide a discharge current I3. When the primary control signal G_{PS} indicates that the primary power switch Q0 is turned on, the driver 120 is configured to select the first drive current I1 or the second drive current I2 to drive the primary power switch Q0 under the control of the monitor signal MS. When the primary control signal G_{PS} indicates that the primary power switch Q0 is turned off, the driver 120 is configured to select the third current source 203, to provide a discharge path to the primary power switch Q0, so as to successfully turn off the primary power switch Q0.

In the example of FIG. 6, the driver 120 further comprises, a switch circuit 204, configured to select between the first current source 201 and the second current source 202 to charge a control terminal of the primary power switch Q0 (i.e., to turn on the primary power switch Q0), and to select the third current source 203 to discharge the control terminal of the primary power switch Q0 (i.e., to turn off the primary power switch Q0) under the control of the primary control signal G_{PS} and the monitor signal M_{S}. In one embodiment of the present invention, the switch circuit 204 selects between the first current source 201 and the second current source 202 means the switch circuit 204 selects the first current source 201, or the second current source 202 to charge the control terminal of the primary power switch Q0.

In one embodiment of the present invention, the first drive current I1 comprises a weak drive current, and the second drive current I2 comprise a strong drive current. For example, the second drive current I2 may have a current value substantially five times of the first drive current I1. When the monitor signal M_{S} indicates that the time interval between two adjacent turn-ons of the primary power switch Q0 is longer than the reference time length, the switch circuit 204 is configured to select the first current source 201, to have the first drive current I1 drive the primary power switch Q0. Accordingly, the primary power switch Q0 turns from the fully OFF state to the fully ON state with the first speed that is relatively slow. When the monitor signal M_{S} indicates that the time interval between two adjacent turn-ons of the primary power switch Q0 is shorter than the reference time length, the switch circuit 204 is configured to select the second current source 202, to have the second drive current I2 drive the primary power switch Q0. Accordingly, the primary power switch Q0 turns from the fully OFF state to the fully ON state with the second speed that is relatively fast.

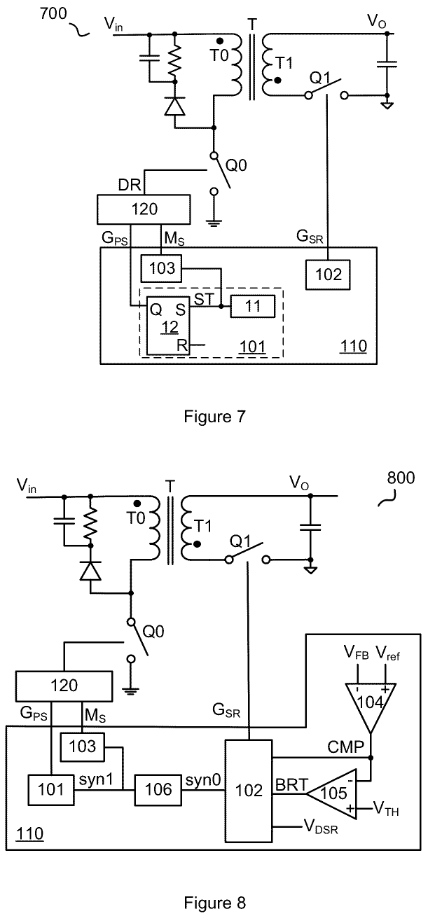

FIG. 7 schematically shows a flyback converter 700 with a circuit configuration of the control circuit 110 in accordance with an embodiment of the present invention. As shown in FIG. 7, the control circuit 110 comprises: a primary controller 101, a secondary controller 102 and a timer 103. The primary controller 101 has a set circuit 11 and a logical circuit (e.g. a RS flip flop) 12. The set circuit 11 is configured to provide a set signal ST to the logical circuit 12 to turn on the primary power switch Q0. The secondary controller 102 is configured to provide the secondary control signal G_{SR}. The timer 103 is configured to time the time interval between two adjacent turn-ons of the primary power switch, to generate the monitor signal M_{S}. When a time interval between two adjacent set signals ST is longer than the reference time length, the driver 120 is configured to provide the weak drive, so that the primary power switch Q0 is controlled to turn to be fully ON from fully OFF with the first speed. When the time interval between two adjacent set signals ST is shorter than the reference time length, the driver 120 is configured to provide the strong drive, so that the primary power switch Q0 is controlled to be fully ON from fully OFF with the second speed.

In one embodiment of the present invention, the set signal ST may be delivered from the secondary side, as shown in below FIG. 8. In other embodiments of the present invention, the set signal ST may be generated at the primary side. For example, when the flyback converter is at start-up stage, the output voltage V_{O} has not reached the set voltage value, and the secondary control has not been built. The primary side would switch automatically without the output voltage information.

FIG. 8 schematically shows a flyback converter 800 with a circuit configuration of the control circuit 110 in accordance with an embodiment of the present invention. The control circuit 110 in FIG. 8 is similar to the control circuit 110 in FIG. 7, with a difference that in the example of FIG. 8, the control circuit 110 further comprises: an error amplifier 104, configured to amplify and integrate a difference between a feedback voltage V_{FB} indicative of the output voltage V_{O} and a reference voltage V_{ref}, to generate a compensation signal CMP; and a comparator (e.g. a hysteresis comparator) 105, configured to compare the compensation signal CMP with a voltage threshold V_{TH}, to generate an indicative signal BRT. The indicative signal BRT indicates the flyback converter 800 to enter and/or exit the burst mode. The secondary controller 102 is configured to generate a secondary signal syn0 and the secondary control signal G_{SR} in response to a signal (e.g., a voltage V_{DSR} across the secondary power switch Q1) indicative of the current flowing through the secondary power switch Q1, the compensation signal CMP and the indicative signal BRT. The control circuit 110 further comprises: a delivery block 106, configured to convert the secondary signal syn to a primary signal syn1. The primary controller 101 is configured to generate the primary control signal G_{PS} in response to the primary signal syn1. The timer 103 is configured to generate the monitor signal M_{S} in response to the primary signal syn1.

In one embodiment of the present invention, if the compensation signal CMP is lower than the voltage threshold V_{TH}, which means the output voltage is relatively low, the flyback converter would enter the burst mode. If the load increases, the compensation signal CMP increases as well. When the compensation signal CMP increases to be higher than a sum of the voltage threshold V_{TH} and a hysteresis value of the comparator 102, the flyback converter would exit the burst mode. When the flyback converter exits from the burst mode, the driver 120 is configured to provide the weak drive, to have the primary power switch turn from the fully OFF state to the fully ON state with the first speed.

In one embodiment of the present invention, the delivery block 106 may comprise an isolation capacitor. In other embodiments of the present invention, the delivery block 106 may comprise other isolation devices, such as opto-coupler.

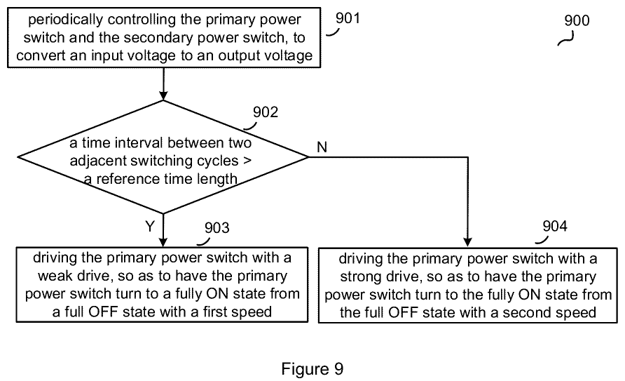

FIG. 9 schematically shows a flowchart 900 of a method used in a flyback converter in accordance with an embodiment of the present invention. The flyback converter includes a primary power switch and a secondary power switch. The method comprises:

Step 901, periodically controlling the primary power switch and the secondary power switch, to convert an input voltage to an output voltage.

Step 902, calculating a time interval between two adjacent turn-ons of the primary power switch: if the time interval between two turn-ons of the primary power switch is longer than a reference time length, going to step 903; and if the time interval between two adjacent turn-ons of the primary power switch is shorter than the reference time length, going to step 904.

Step 903, driving the primary power switch with a weak drive, so as to have the primary power switch turn to a fully ON state from a fully OFF state with a first speed. And

Step 904, driving the primary power switch with a strong drive, so as to have the primary power switch turn to the fully ON state from the fully OFF state with a second speed.

In one embodiment of the present invention, the first speed is lower than the second speed.

In one embodiment of the present invention, driving the primary power switch with a strong drive comprising provide a relatively high drive current, or a relatively high drive voltage, or a relatively strong drive pulse; and driving the primary power switch with a weak drive comprising provide a relatively low drive current, or a relatively low drive voltage, or a relatively weak drive pulse.

In one embodiment of the present invention, driving the primary power switch with a weak drive during a start-up process of the flyback converter.

In one embodiment of the present invention, the method further comprises: when the flyback converter is not under the burst mode, driving the primary power switch with a strong drive; and when the flyback converter enters the burst mode and then exits from the burst boost, driving the primary power switch with a weak drive. When the flyback converter is under the burst mode, controlling the primary power switch and the secondary power switch to be idle (i.e. to not switch between the ON state and the OFF state).

In one embodiment of the present invention, when the flyback converter enters the burst mode and then exits from the burst boost, at the first N switching cycles just after the flyback exists from the burst mode, driving the primary power switch with a weak drive; and after the first N switching cycles since the flyback converter exits from the burst mode, driving the primary power switch with a strong drive. N is an integer larger than 1.

Several embodiments of the foregoing flyback converter provide a weak drive when the time interval between two adjacent turn-ons of the primary power switch is longer than the reference time length (e.g., when the system is under the burst mode or at the start-up stage), to have the primary power switch slowly turns to the fully ON state from the fully OFF state. Thus, the voltage spike across the secondary power switch is reduced and the system performance is improved.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A flyback converter, comprising:
a primary power switch, coupled to a primary winding of a transformer;
a secondary power switch, coupled to a secondary winding of the transformer; and
a driver, configured to provide a drive signal to drive the primary power switch;
wherein:
if a time interval between two adjacent turn-ons of the primary power switch is longer than a reference time length, the driver is configured to provide a weak drive, so that the primary power switch is controlled to turn to a fully ON state from a fully OFF state with a first speed; and
if the time interval between two adjacent turn-ons of the primary power switch is shorter than the reference time length, the driver is configured to provide a strong drive, so that the primary power switch is controlled to turn to the fully ON state from the fully OFF state with a second speed.

2. The flyback converter of claim 1, wherein:
the driver is configured to provide the weak drive to the primary power switch at a start-up stage.

3. The flyback converter of claim 1, wherein:
the first speed is lower than the second speed.

4. The flyback converter of claim 1, wherein:
when the flyback converter enters a burst mode and then exit from the burst mode, the driver is configured to provide the weak drive to the primary power switch; and
when the flyback converter is not under the burst mode, the driver is configured to provide the strong drive to the primary power switch.

5. The flyback converter of claim 1, further comprising a control circuit, having a timer configured to time the time interval between two adjacent turn-ons of the primary power switch.

6. The flyback converter of claim 1, wherein the driver comprises:
a first current source, configured to provide a first drive current; and
a second current source, configured to provide a second drive current; wherein when the primary control signal indicates that the primary power switch is turned on:
if the time interval between two adjacent turn-ons of the primary power switch is longer than the reference time length, the driver is configured to drive the primary power switch with the first drive current; and
if the time interval between two adjacent turn-ons of the primary power switch is shorter than the reference time length, the driver is configured to drive the primary power switch with the second drive current; and wherein the second drive current is higher than the first drive current.

7. The flyback converter of claim 6, wherein the driver further comprises:
a third current source, configured to provide a discharge current; wherein when the primary control signal indicates that the primary power switch is turned off, the driver is configured to drive the primary power switch with the discharge current.

8. A control and drive circuit, comprising:
a primary controller, configured to generate a primary control signal used to control a primary power switch; and
a timer, configured to time a time interval between two adjacent turn-ons of the primary power switch, wherein:
if the time interval between two adjacent turn-ons of the primary power switch is longer than a reference time length, the primary controller is configured to control the primary power switch to turn to a fully ON state from a fully OFF state with a first speed; and
if the time interval between two adjacent turn-ons of the primary power switch is shorter than the reference time length, the primary controller is configured to control the primary power switch to turn to the fully ON state from the fully OFF state with a second speed.

9. The control and drive circuit of claim 8, further comprising: a drive circuit, configured to:
provide a weak drive if the time interval between two adjacent turn-ons of the primary power switch is longer than the reference time length, to have the primary power switch turn to the fully ON state from the fully OFF state with the first speed; and
provide a strong drive if the time interval between two adjacent turn-ons of the primary power switch is shorter than the reference time length, to have the primary power switch turn to the fully ON state from the fully OFF state with the second speed.

10. The control and drive circuit of claim 9, wherein the driver comprises:
a first current source, configured to provide a first drive current; and
a second current source, configured to provide a second drive current; wherein when the primary control signal indicates that the primary power switch is turned on:
if the time interval between two adjacent turn-ons of the primary power switch is longer than the reference time length, the driver is configured to drive the primary power switch with the first drive current; and
if the time interval between two adjacent turn-ons of the primary power switch is shorter than the reference time length, the driver is configured to drive the primary power switch with the second drive current; and wherein the second drive current is higher than the first drive current.

11. The control and drive circuit of claim 10, further comprising:
a third current source, configured to provide a discharge current; wherein when the primary control signal indicates that the primary power switch is turned off, the driver is configured to drive the primary power switch with the discharge current.

12. The control and drive circuit of claim 8, wherein:
the primary power switch is controlled to turn to the fully ON state from the fully OFF state with the first speed at a start-up stage.

13. The control and drive circuit of claim 8, wherein:
the first speed is lower than the second speed.

14. The control and drive circuit of claim 8, wherein:
when the flyback converter enters a burst mode and then exit from the burst mode, the primary power switch is controlled to turn to the fully ON state from the fully OFF state with the first speed; and
when the flyback converter is not under the burst mode, the primary power switch is controlled to turn to the fully ON state from the fully OFF state with the second speed.

15. A control and drive circuit, comprising:
a primary controller, configured to generate a primary control signal used to control a primary power switch; and
a driver, configured to provide a drive signal to drive the primary power switch;
wherein:
if a time interval between two adjacent turn-ons of the primary power switch is longer than a reference time length, the driver is configured to provide a weak drive, to have the primary power switch turn to a fully ON state from a fully OFF state with a first speed; and
if the time interval between two adjacent turn-ons of the primary power switch is shorter than the reference time length, the driver is configured to provide a strong drive, to have the primary power switch turn to the fully ON state from the fully OFF state with a second speed.

16. The control and drive circuit of claim 15, further comprising:
a timer, configured to time the time interval between two adjacent turn-ons of the primary power switch.

17. The control and drive circuit of claim 15, wherein driver comprises:
a first current source, configured to provide a first drive current; and
a second current source, configured to provide a second drive current; wherein when the primary control signal indicates that the primary power switch is turned on:
if the time interval between two adjacent turn-ons of the primary power switch is longer than the reference time length, the driver is configured to drive the primary power switch with the first drive current; and
if the time interval between two adjacent turn-ons of the primary power switch is shorter than the reference time length, the driver is configured to drive the primary power switch with the second drive current; and wherein the second drive current is higher than the first drive current.

18. The control and drive circuit of claim 15, wherein:
the driver is configured to provide the weak drive at a start-up stage.

19. The control and drive circuit of claim 15, wherein:
when the flyback converter enters a burst mode and then exit from the burst mode, the driver is configured to provide the weak drive; and
when the flyback converter is not under the burst mode, the driver is configured to provide the strong drive.

20. The control and drive circuit of claim 15, wherein:
the first speed is lower than the second speed.
